(19) United States
(12) Patent Application Publication
(10) Pub. No.: US 2026/0220587 A1
(43) Pub. Date: Jul. 30, 2026

(54) SYSTEMS AND METHODS FOR SMOOTHING A TRUCK FLOW TO A DESTINATION NODE

(71) Applicant: Walmart Apollo, LLC, Bentonville, AR (US)

(72) Inventors: Shiv Krishna Jaiswal, Jaunpur (IN); Amin Gholami, Redmond, WA (US); Balakrishnan Vijay, Bangalore (IN); Abhishek Chawla, Bengaluru (IN); Jing Huang, San Jose, CA (US); Rajesh Palanisamy, Bengaluru (IN); Sachin Roy, Kanpur Nagar (IN); Sriyansa Dash, Bengaluru (IN); Mingang Fu, Palo Alto, CA (US)

(73) Assignee: Walmart Apollo, LLC, Bentonville, AR (US)

(21) Appl. No.: 19/040,656

(22) Filed: Jan. 29, 2025

(51) Int. Cl. G06Q 10/083; G06Q 10/0631

(52) U.S. Cl. CPC G06Q 10/083; G06Q 10/06315

(57) ABSTRACT

A computer-implemented method is provided that can smooth a truck flow to a destination node. Input data can be received by a truck flow planning (TFP) system, including truck demand data, truck capacity constraints, and node capacity constraints. The TFP system can include truck demand projection (TDP), truck flow optimization (TFO), and receding horizon control (RHC) components. Truck demand can be projected over a horizon. A plan for the truck flow can be generated that reduces variability while at least maintaining inventory health and can include formulating the plan as a Mixed Integer Programming (MIP) problem. The plan can be adjusted when one or more of new input data features, outputs of the RHC component, outputs of a truck planning optimization (TPO) component, or outputs of a truck load optimization (TLO) component are within thresholds. The plan, as generated and adjusted, can be based on a rolling time window.

### INCORPORATION BY REFERENCE

The entire disclosures of U.S. Provisional Ser. No. 63/627,622, filed on Jan. 31, 2024, and U.S. Non-Provisional Ser. No. 18/103,212, filed on Jan. 30, 2023, are hereby incorporated by reference in their entirety for all purposes.

### TECHNICAL FIELD

This disclosure relates generally to systems and methods for truck flow to a destination node, and more particularly, to systems and methods for smoothing a truck flow to a destination node.

### BACKGROUND

In modern supply chain management, relying solely on just-in-time (JIT) principles for ordering/picking up items from vendors and transporting the items to a subsequent destination can lead to significant logistical challenges. For instance, fluctuating truck demand over a predetermined period can result in peak capacity violations, underutilization of resources, and increased transportation procurement costs in relation to the needed trucks associated with the subsequent destination. Addressing these logistical challenges requires a solution that can reduce truck flow variability while ensuring business constraints are met and sales performance is at least maintained.

### BRIEF DESCRIPTION OF THE DRAWINGS

To facilitate further description of the embodiments, the following drawings are provided in which:

FIG. 1 illustrates a block diagram of an inbound order optimization (IO2) system that includes a truck flow planning (TFP) system for smoothing a truck flow to a destination node, according to an example embodiment;

FIG. 2 illustrates a block diagram of the architecture of the TFP system, included in the IO2 system, for smoothing the truck flow to the destination node, according to an example embodiment;

FIG. 3A illustrates nodes in a transportation pathway, including source nodes and destination nodes, related to the IO2 system that includes the TFP system for smoothing the truck flow to the destination node, according to an example embodiment;

FIG. 3B illustrates an adaptive planning process performed by a receding horizon control (RHC) component included in the TFP system, according to an example embodiment;

FIG. 3C illustrates a graphically represented problem associated with ‘need trucks’ and a graphically represented solution with ‘target trucks’ associated with a destination node, according to an example embodiment;

FIG. 3D shows an impact of using the TFP system: actual (with smoothing) vs. simulated (without smoothing) coefficient of variance by ship-point and demonstrated improvements, according to an example embodiment;

FIG. 4 illustrates a flowchart of a computer-implemented method for smoothing a truck flow to a destination node, according to an example embodiment;

FIG. 5 illustrates a front elevational view of a computer system that is suitable for implementing an embodiment of the system disclosed in FIG. 1, according to an example embodiment; and

FIG. 6 illustrates a representative block diagram of an example of the elements included in the circuit boards inside a chassis of the computer system of FIG. 5, according to an example embodiment.

### DETAILED DESCRIPTION

Embodiments disclosed herein relate to systems and methods for smoothing/optimizing a truck flow (e.g., reducing variability and helping to ensure a steady, balanced flow of trucks and/or items to avoid over-or under-supply situations) to a destination node that can include a truck flow planning (TFP) system. The TFP system can offer a novel solution to the persistent logistical challenges encountered by systems and methods of managing truck demand variability at destination nodes. Traditional systems and methods often struggle with peak capacity violations, underutilization of resources, and increased transportation procurement costs. Embodiments of the TFP system disclosed herein can address, for example, these logistical challenges by strategically pulling forward trucks to smooth truck demand over a predetermined horizon, which can smooth resource utilization and maintain business constraints while improving associated systems.

According to some embodiments, the TFP system can collect various types of data, including one or more of truck demand data, truck capacity constraints, or node capacity constraints associated with a source node and/or a destination node. This collected data can undergo feature extraction and/or analysis and can form the basis for accurate truck demand projections by the Truck Demand Projection (TDP) component. The Truck Flow Optimization (TFO) component can smooth the truck flow based on these truck demand projections, minimizing truck flow variance and ensuring truck counts remain within predetermined ranges at the source node and/or the destination node. The optimization process of the TFO component can use a Mixed Integer Programming (MIP) (e.g., mixed integer linear programming (MILP) and/or mixed integer quadratic programming (MIQP), etc.) formulation, which can incorporate constraints to prevent, for example, capacity breaches, and can help ensure that the total number of trucks matches the truck demand throughout a predetermined horizon.

The TFP system can include a receding horizon control (RHC) component, which can dynamically adjust the smoothed truck flow plan (e.g., continuously, in real-time, dynamically, etc.). By using a rolling time window, the RHC component can adapt to current truck demand and truck supply conditions, ensuring short-term efficiency while maintaining long-term strategic goals. This dynamic adjustment capability can significantly enhance the TFP system's responsiveness and adaptability compared to traditional static planning methods. In an embodiment, the dynamic adjustment can include dynamic optimization.

By integrating these advanced components, the TFP system can, for example, reduce peak capacity violations, minimize underutilization of resources, and lower transportation procurement costs. The TFP system's ability to dynamically adjust plans based on, for example, real-time data inputs can enhance the overall functionality and responsiveness of the computing environment. This smoothing the truck flow to the destination node can lead to more efficient system resource utilization and improved operational performance, providing a robust and adaptive solution to the challenges that are associated with variable truck demand. The inherent benefits of the TFP system over traditional methods can include enhanced efficiency, reduced costs, and improved reliability, making it advantageous for modern supply chain management systems. Traditional supply chain management systems can incur significant avoidable resource utilization and difficulty in negotiating latent logistical challenges.

According to some example embodiments, a system can be provided that can include a processor and a non-transitory computer-readable medium storing computing instructions that, when executed on the processor, can cause the processor to perform operations. The operations can include a computer-implemented method for smoothing a truck flow to a destination node. Input data can be received, by a truck flow planning (TFP) system. The input data, as received, can include truck demand data, truck capacity constraints, and node capacity constraints. The TFP system can include a truck demand projection (TDP) component, a truck flow optimization (TFO) component, and a receding horizon control (RHC) component. Truck demand at the destination node can be projected over a predetermined horizon, using the TDP component, based on the input data, as received. A plan for the truck flow to the destination node can be generated, using the TFO component, based on the truck demand over the predetermined horizon, as projected. The generating can include formulating the plan for the truck flow to the destination node as a Mixed Integer Programming (MIP) problem. The plan for the truck flow, as generated, can reduce truck flow variability at the destination node while at least maintaining inventory health at the destination node. The plan for the truck flow to the destination node, as generated, can be adjusted when one or more of (1) new input data features, (2) outputs of the RHC component, (3) outputs of a truck planning optimization (TPO) component, or (4) outputs of a truck load optimization (TLO) component are within one or more respective predetermined thresholds.

According to some example embodiments, a computer-implemented method for smoothing a truck flow to a destination node can be provided. The computer-implemented method can include receiving input data, by a truck flow planning (TFP) system. The input data, as received, can include truck demand data, truck capacity constraints, and node capacity constraints. The TFP system can include a truck demand projection (TDP) component, a truck flow optimization (TFO) component, and a receding horizon control (RHC) component. Truck demand at the destination node can be projected over a predetermined horizon using the TDP component based on the input data, as received. A plan for the truck flow to the destination node can be generated, using the TFO component, based on the truck demand over the predetermined horizon, as projected. The generating can include formulating the plan for the truck flow to the destination node as a Mixed Integer Programming (MIP) problem. Constraints used in the smoothing the plan for the truck flow to the destination node can include a maximum truck constraint, a no shortage of trucks constraint, and a needed truck conservation constraint. The plan for the truck flow, as generated, can reduce truck flow variability at the destination node while at least maintaining inventory health at the destination node. The plan for the truck flow to the destination node, as generated, can be adjusted when one or more of (1) new input data features, (2) outputs of the RHC component, (3) outputs of a truck planning optimization (TPO) component, or (4) outputs of a truck load optimization (TLO) component are within one or more respective predetermined thresholds. The plan for the truck flow, as generated and adjusted, can be based on a rolling time window.

According to some example embodiments, a non-transitory computer-readable medium storing computing instructions can be provided. The computing instructions, when executed on a processor, can cause the processor to perform operations including a computer-implemented method for smoothing a truck flow to a destination node. Input data can be received, by a truck flow planning (TFP) system. The input data, as received, can include truck demand data, truck capacity constraints, and node capacity constraints. The TFP system can include a truck demand projection (TDP) component, a truck flow optimization (TFO) component, and a receding horizon control (RHC) component. Truck demand at the destination node can be projected over a predetermined horizon using the TDP component based on the input data, as received. A plan for the truck flow to the destination node can be generated, using the TFO component, based on the truck demand over the predetermined horizon, as projected. The generating can include formulating the plan for the truck flow to the destination node as a Mixed Integer Programming (MIP) problem. Constraints used in the smoothing the plan for the truck flow to the destination node can include a maximum truck constraint, a no shortage of trucks constraint, and a needed truck conservation constraint. The plan for the truck flow, as generated, can reduce truck flow variability at the destination node while at least maintaining inventory health at the destination node. The plan for the truck flow to the destination node, as generated, can be adjusted based on one or more of (1) new input data features, (2) outputs of the RHC component, (3) outputs of a truck planning optimization (TPO) component, or (4) outputs of a truck load optimization (TLO) component being within one or more respective predetermined thresholds. The plan for the truck flow, as generated and adjusted, can be based on a rolling time window.

Although the embodiments illustrated and described herein consistently refer to trucks, the present disclosure is not limited to this type of transport vehicle. For example, trucks can be substituted with various other transport vehicle types or even non-vehicle entities, such as delivery drones. Similarly, while the embodiments disclosed herein consistently refer to a pairing of a source node and a consecutive destination node for inbound nodes, this is not to be construed as an absolute limitation. For example, multiple nodes, which may not be consecutive and may additionally or alternatively include outbound and/or “last mile” nodes, can also be utilized. Furthermore, although the embodiments disclosed herein consistently refer to truck flow variability and its features in the context of inbound order optimization, this is not to be construed as restrictive. For example, flow variability can additionally or alternatively pertain to different transport vehicles, delivery drones, individuals, things, items, and their respective features, and can be related to various other contexts, such as electricity grid management.

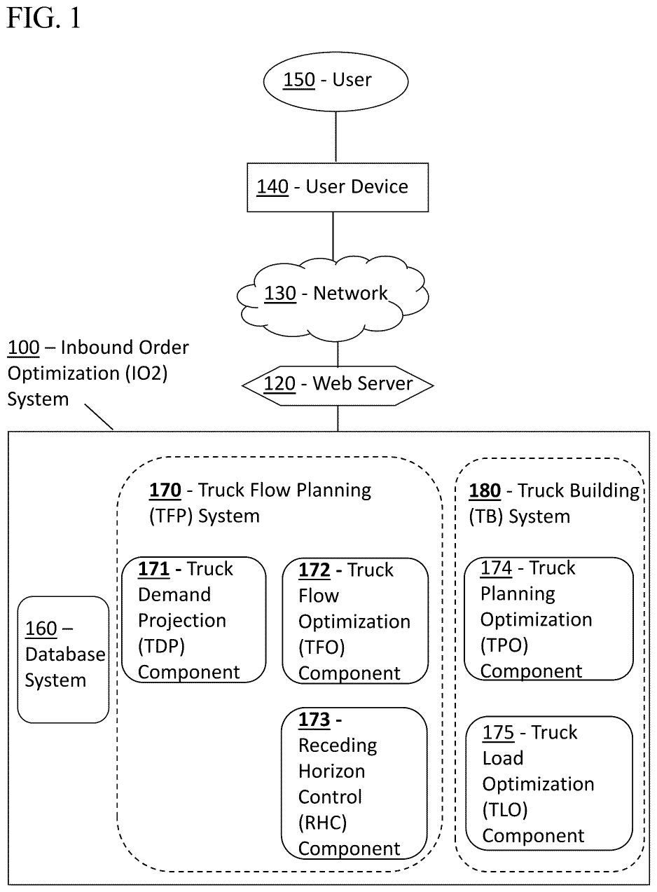

FIG. 1 illustrates a block diagram of an inbound order optimization (IO2) system that includes a truck flow planning (TFP) system for smoothing truck flow to a destination node, according to an example embodiment.

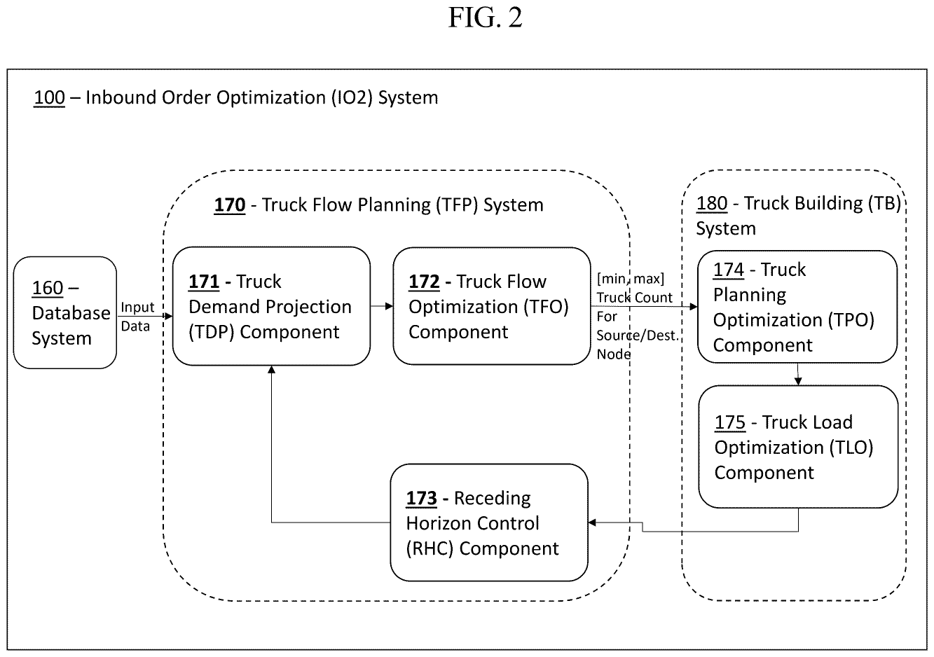

FIG. 2 illustrates a block diagram of the architecture of the TFP system for smoothing truck flow to the destination node, included in the IO2 system, according to an example embodiment.

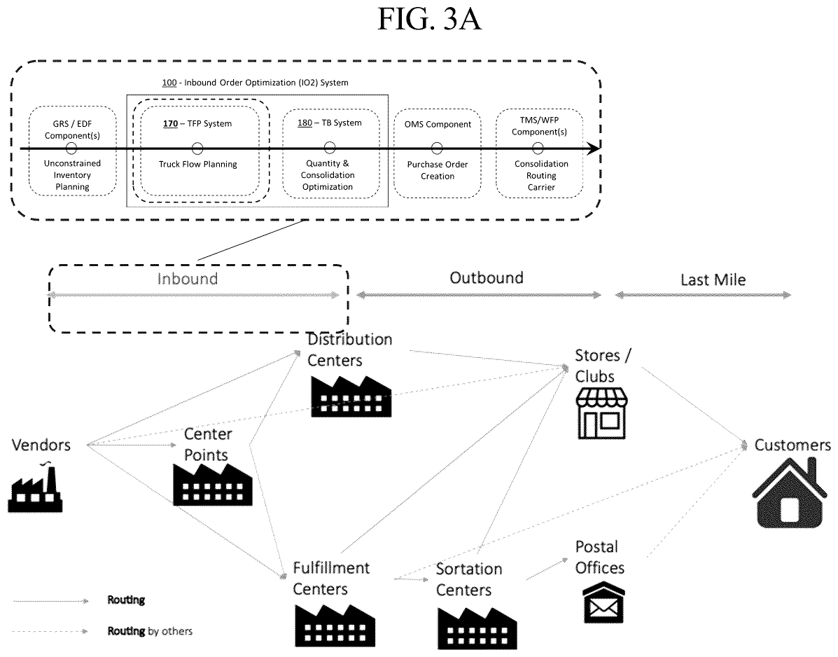

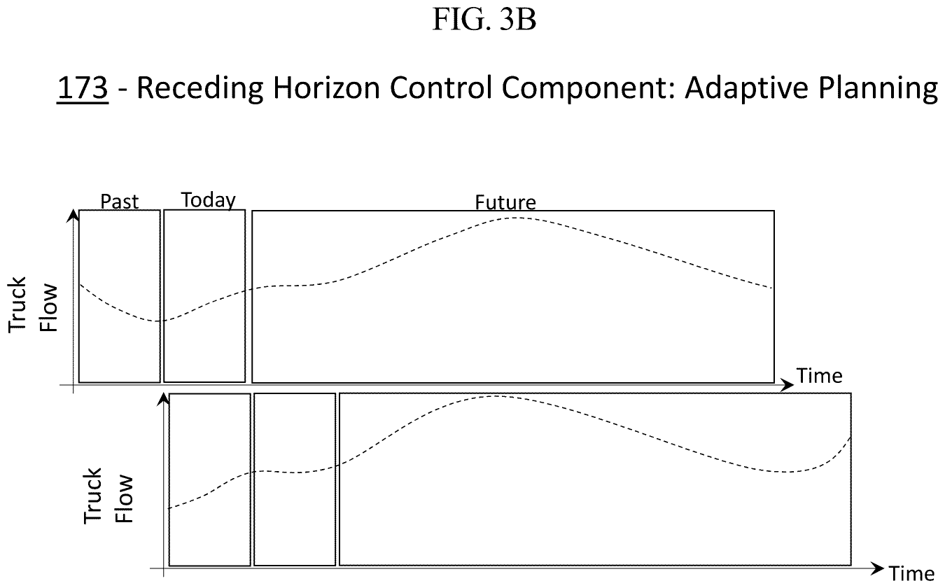

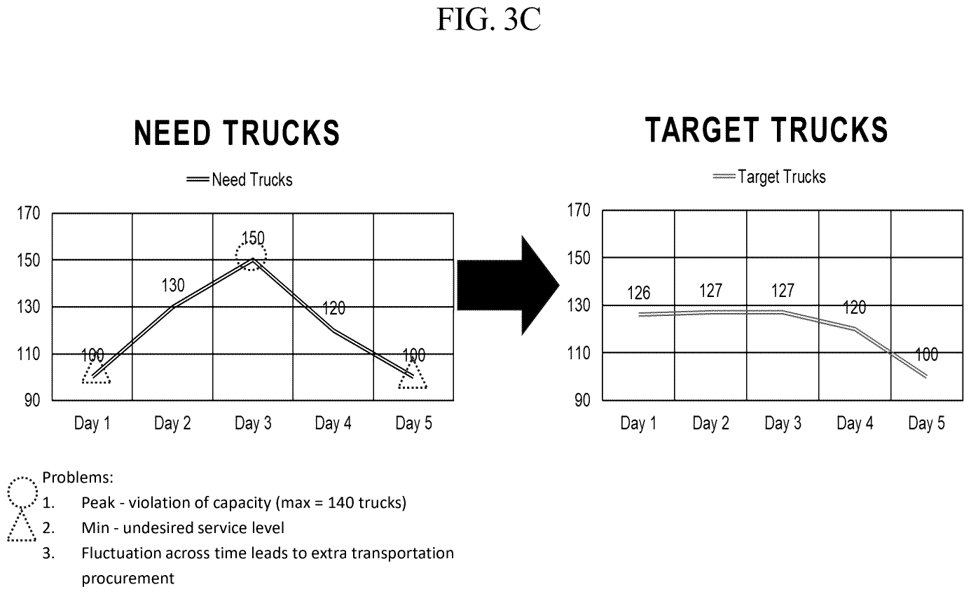

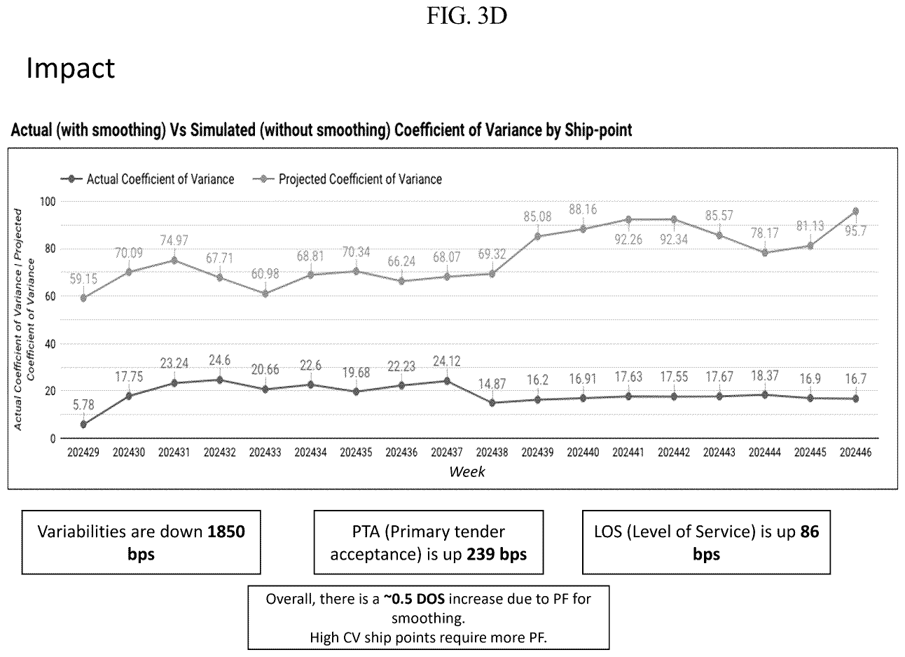

The IO2 system 100 can smooth the flow of transport vehicles (e.g., trucks) and/or machines (e.g., delivery drones) to a destination node (e.g., center point, distribution center, fulfillment center, etc.) from a source node (e.g., vendor, center point, intermediate node, etc.), such as for at least one segment of a transportation pathway (e.g., an inbound segment, such as illustrated with reference to the example embodiment of FIG. 3A).

The IO2 system 100 can include a truck flow planning (TFP) system 170. The IO2 system 100 can further include one or more of a truck building (TB) system 180 or a database system 160. The IO2 system 100 can be connected to a web server 120 and can be further connected to a network 130 via the web server 120. The IO2 system 100 can be accessed by a user 150, for example, via a user device 140, which can connect to the web server 120 via the network 130.

The TFP system 170 can include a truck demand projection (TDP) component 171, a truck flow optimization (TFO) component 172, and a receding horizon control (RHC) component 173. Each component can perform specific, cooperative, and/or overlapping functions/steps/processes and can interact with one or more of the other components to help ensure efficient and adaptive truck flow management, such as in a cyclical process.

The TFP system 170 can receive input data from the database system 160, which can include one or more of truck demand data, item demand data, orders (e.g., placed by the user 150), items included in the orders (e.g., stocked, shipped, ordered items, etc.), different truck types (e.g., live, drop, required for specific temperature-controlled chambers, time-specific delivery appointments, etc.), truck capacity constraints (e.g., truck manifests, dimensions, volumes, trailers, transportation restrictions, carbon emissions, etc.), transportation pathways (e.g., itineraries, lanes, nodes, transportation pathway segments, routes, etc.), or node capacity constraints (e.g., truck yard/parking lot dimensions/volumes, truck yard/parking lot occupancies/availabilities, dock door/dock bay dimensions, dock door/dock bay occupancies/vacancies, etc.) for the destination node and/or the source node. The TDP component 171 can project truck demand at the destination node over a predetermined horizon (e.g., a predetermined future time period) based on this input data (e.g., analysis and/or extracted features). This projection can include estimating truck demands for one or more of the different truck types.

The TFO component 172 can generate a plan for the truck flow to the destination node based on the projected truck demand. This can involve formulating/determining/implementing the plan as a mixed integer programming (MIP) problem, which can include incorporating one or more constraints to help ensure optimal truck flow. The constraints can include a maximum truck constraint, which can help ensure that the number of trucks on each day does not exceed a defined maximum unless unavoidable and/or based on user input. This maximum (max) truck constraint can be represented by the equation: [x_{d}−s_{d}≤M_{d}∀d∈D] in which (x_{d}) can represent the number of trucks on day (d), (s_{d}) can represent the max truck breach on day (d), and (M_{d}) can represent the maximum number of trucks allowed on day (d). This constraint can modify the MIP formulation by adding a variable (s_{d}) to account for any breaches in the maximum truck capacity.

The no shortage of trucks constraint can help ensure that the total number of trucks sent to the destination node until any given day is at least equal to the total number of needed trucks until that day. This no shortage of trucks constraint can be represented by the equation:

$$[ {\sum }_{{d}^{′} \leq d} {n}_{{d}^{′}} \leq {\sum }_{{d}^{′} \leq d} {x}_{d} , ∀ d ∈ D ]$$

in which (n_{d′}) can represent the need-truck on date (d′). This constraint can help ensure that the MIP formulation does not allow for capping of truck numbers.

The need truck conservation constraint can help ensure that the total number of trucks (also referred to herein as target trucks) planned for/sent to the destination node over the predetermined horizon equals the total number of ‘need trucks’ (also referred to herein as needed trucks), such as illustrated with reference to the example embodiment of FIG. 3C. This need truck conservation constraint can be represented by the equation:

$$[ {\sum }_{d ∈ D} {n}_{d} = {\sum }_{d ∈ D} {x}_{d} ] .$$

This constraint can help ensure that the MIP formulation maintains a balance between the total trucks needed at the destination node and the total trucks sent over the predetermined horizon to the destination node.

An objective function for the TFO component 172 can be to minimize a max capacity breach, which imposes a penalty for exceeding a predetermined limit or a maximum capacity of trucks at the destination node. It can also minimize the coefficient of variation (CV), as illustrated in FIG. 3D, by reducing the deviation from the baseline need-truck and can minimize the number of trucks required on high-demand days by strategically sending some trucks/trailers in advance (e.g., pulling forward trucks). The combined objective function can be represented by:

$$[ {A}_{0} ( {\sum }_{d ∈ D} {s}_{d} ) + {A}_{1} ( {\sum }_{d ∈ D} {{s}_{d} ( {x}_{d} - b )}^{2} ) + {A}_{2} ( {\sum }_{d ∈ D} {y}_{d} ) ]$$

in which (A₀, (A₁), and (A₂) can represent weights/importance of the corresponding terms, (b) can represent the baseline need-truck, and (yd) can represent the accumulated pulled forward (PF) trucks till date (d). Pulling forward can refer to the strategy of scheduling trucks to arrive earlier than originally planned (e.g., as would be based on JIT principles) to smooth out the flow and reduce variability at the destination node. This can help ensure a steady supply of trucks and/or items and can prevents shortages and/or delays. By pulling forward trucks, companies can better manage inventory levels and avoid stockouts, especially at high coefficient of variation (CV) ship points, which indicate greater variability in demand. This objective function can modify the MIP formulation by incorporating penalties for capacity breaches, deviations from the baseline, and/or the strategic use of pull forward trucks.

To ensure optimal truck flow and supply chain efficiency, the TFP system 170 can utilize the MIP with one or more of the constraints. The TFP system 170 can maintain a balance between the number of trucks scheduled (planned) and the truck demand at the destination node. This can involve helping to ensure that the cumulative number of trucks scheduled to pick up from a source node and deliver to the destination node can at least meet the cumulative demand at the destination node up to any given day and prevent truck and/or item shortages. The approach can also avoid bringing in trucks more than a predetermined maximum amount for any given day within the predetermined horizon, thereby reducing truck and/or item variability without causing sales loss. The TFP system 170 can maintain truck counts within predetermined minimum and predetermined maximum limits each day and discourages pulling forward excess trucks too early, which can prevent prolonged storage at the destination node and/or inactivity. These principles can be enforced through the one or more constraints, which include one or more of the maximum truck constraint, the no shortage of trucks constraint, or the need truck conservation constraint. These constraints (e.g., collectively) in conjunction with the MIP can help ensure a smooth and efficient truck flow.

The RHC component 173 can adjust the truck flow plan (e.g., in real-time) based on the most current demand and supply information either directly or indirectly by output to the TDP component 171 and/or the TFO component 172, cooperatively. The RHC component 173 can use a rolling time window (e.g., a rolling predetermined horizon) to update (e.g., continuously, periodically, dynamically, daily, etc.) the TFP system 170, which can help ensure adaptive, short-term efficiency while maintaining long-term strategic goals, such as illustrated with reference to the example embodiment of FIG. 3B. The RHC component 173 can adjust the plan for the truck flow when/based on one or more of new input data features, outputs from the TFO component 172, TPO component 174, or TLO component 175 are/being within respective predetermined thresholds. In an embodiment, the adjustment by the RHC component 173 can include optimization based on the same information, features, and outputs.

The TB system 180 can include the truck planning optimization (TPO) component 174 and/or the truck load optimization (TLO) component 175. The TPO component 174 can determine a number of trucks for each lane on the current day based on input from the TFP system 170. The TLO component 175 can decide the order quantity of each item and consolidate them into trucks for each lane on the current day.

The TFP system 170 can plan the minimum and maximum numbers of trucks across multiple periods for each source node (ship points) of lanes, with the main objective of smoothing the flow. Given input from the TFP system 170, the TPO component 174 can decide the detailed number of trucks for each lane on the current day. Subsequently, given input from the TPO component 174, the TLO component 175 can decide an order quantity of each item and consolidate them into trucks for each lane on the current day.

An impact of implementing the IO2 system 100 that can include the TFP system 170 can be significant, such as illustrated with reference to the example embodiment of FIG. 3D. Variabilities can be reduced by 1850 basis points (bps), and primary tender acceptance (PTA) can increase by 239 bps. Overall, there can be a ~0.5 days of supply (DOS) increase due to pull forward (PF) for smoothing. High coefficient of variation (CV) ship points, which measure the variability of truck shipments relative to the mean, can require more PF to maintain a steady supply. Level of service (LOS) can increase by 86 bps. CV is defined as the standard deviation divided by the mean. Reducing CV leads to more consistent and reliable truck flow, improving PTA and LOS. PTA measures the percentage of shipments accepted by the primary carrier on the first offer, and LOS reflects the on-time arrival of the trucks being ordered.

PTA can be a crucial metric that measures a percentage of shipments and/or loads accepted by the primary carrier and/or transportation provider upon the first offer (tender). PTA can reflect, for example, the primary carrier's reliability and willingness to accept the shipments as per the agreed-upon terms and conditions. A high PTA rate indicates that the primary carrier is consistently available and dependable, which can be crucial for maintaining a smooth and efficient supply chain. Conversely, a low acceptance rate might suggest issues with carrier capacity, service levels, or misalignment between the shipper's needs and the carrier's capabilities.

In summary, some embodiments of the IO2 system 100 can, for example, receive input data from the database system 160, project truck demand through the TDP component 171, generate an optimized truck flow plan through the TFO component 172, and adjust the plan in real-time through the RHC component 173. The TB system 180 can further affect the truck flow plan by determining the detailed number of trucks and consolidating items into trucks. This IO2 system 100 that can include the TFP system 170 can help ensure efficient and adaptive management of truck demand and truck flow.

The IO2 system 100, the TFP system 170, and/or the TB system 180, are example embodiments, and embodiments thereof are not limited to just the explicit embodiments illustrated and described herein. The IO2 system 100, the TFP system 170, and/or the TB system 180 can be employed in many different embodiments or examples not specifically depicted or described herein. In some embodiments, certain elements, modules, or systems of the IO2 system 100, the TFP system 170, and/or the TB system 180 can perform various procedures, processes, and/or activities. In other embodiments, the procedures, processes, and/or activities can be performed by other suitable elements, modules, or systems of the IO2 system 100, the TFP system 170, and/or the TB system 180.

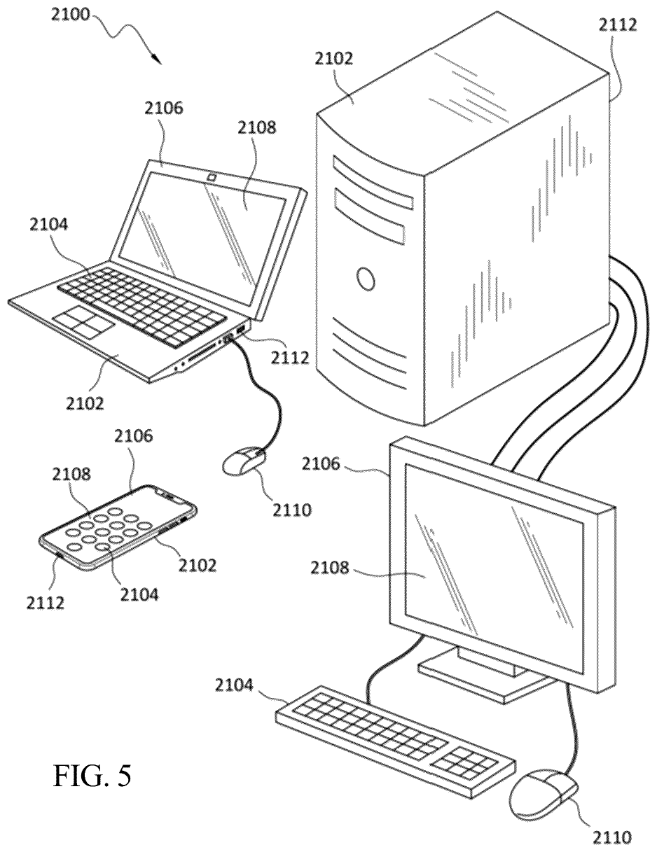

The IO2 system 100, the TFP system 170, the TB system 180, the database system 160, and/or the web server 120 can each be a computer system, such as computer system 2100 (FIG. 5), as described below, and can each be a single computer, a single server, or a cluster or collection of computers or servers, or a cloud of computers or servers. In another embodiment, a single computer system can host the IO2 system 100, the TFP system 170, the TB system 180, the database system 160, and/or the web server 120.

In some embodiments, the web server 120 can be in data communication through a network 130 with one or more user devices, such as the user device 140. The user device 140 can be part of the IO2 system 100 or external to the IO2 system 100. The network 130 can be the Internet or another suitable network. In some embodiments, the user device 140 can be used by administrators/dispatchers/truck drivers, such as the user 150. In many embodiments, the web server 120 can host one or more websites and/or mobile application servers. For example, the web server 120 can be a web server that hosts a website, or provides a server that interfaces with an application (e.g., a mobile application), for the user device 140, which can allow the user to smooth the truck flow to the destination node and/or receive truck flow plans, as generated or adjusted, therefrom, etc.

In some embodiments, an internal network that is not open to the public can be used for communications between the TFP system 170 and the web server 120 within the IO2 system 100. Accordingly, in some embodiments, the TFP system 170 (and/or the software used by such systems) can refer to a back end of the IO2 system 100 operated by an operator and/or administrator of the IO2 system 100, and the web server 120 (and/or the software used by such systems) can refer to a front end of the IO2 system 100, as is can be accessed and/or used by one or more users, such as the user 150, using the user device 140. In these or other embodiments, the operator and/or administrator of the IO2 system 100 can manage the IO2 system 100, the processor(s) of the IO2 system 100, and/or the memory storage unit(s) of the IO2 system 100 using the input device(s) and/or display device(s) of the IO2 system 100.

In certain embodiments, the user devices (e.g., user device 140) can be desktop computers, laptop computers, mobile devices, and/or other endpoint devices used by one or more users (e.g., user 150). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand.

Examples of mobile devices can include (i) an iPod®, iPhone®, iTouch®, iPad®, MacBook® or similar product by Apple Inc. of Cupertino, California, United States of America, and/or (ii) a Galaxy™ or similar product by the Samsung Group of Samsung Town, Seoul, South Korea. Further, in the same or different embodiments, a mobile device can include an electronic device configured to implement the iPhone® operating system by Apple Inc. of Cupertino, California, United States of America, the Android™ operating system developed by the Open Handset Alliance, or another suitable operating system.

In many embodiments, the IO2 system 100, the TFP system 170, the TB system 180, the database system 160, and/or the web server 120 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). The input device(s) and the display device(s) can be coupled thereto in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of the IO2 system 100, the TFP system 170, the TB system 180, and/or the web server 120. In a similar manner, the processors and/or the non-transitory computer-readable media can be local and/or remote to each other.

In many embodiments, the IO2 system 100, the TFP system 170, the TB system 180, and/or the web server 120 also can be configured to communicate with one or more databases, such as the database system 160. The database system 160 can include various types of data, relevant to the smoothing the truck flow to the destination node, such as one or more of (1) the input data and/or features thereof, (2) outputs of the RHC component 173, (3) outputs of the TPO component 174, (4) outputs of the TLO component 175, (5) respective predetermined thresholds, (6) the plan(s) for the truck flow(s), as generated or adjusted, (7) the predetermined horizon(s), (8) impact metrics, (9) transportation pathway(s) and/or nodes thereof, (6) MIP constraints, etc. The one or more databases can be stored on one or more memory storage units (e.g., non-transitory computer readable media), which can be similar or identical to the one or more memory storage units (e.g., non-transitory computer readable media) described with respect to computer system 2100 (FIG. 5). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Examples of database management systems can include MySQL (Structured Query Language) Database, PostgreSQL Database, Microsoft SQL Server Database, Oracle Database, SAP (Systems, Applications, & Products) Database, and IBM DB2 Database.

The IO2 system 100, the TFP system 170, the TB system 180, web server 120, and/or the database system 160 can be implemented using any suitable manner of wired and/or wireless communication. Accordingly, the IO2 system 100 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Examples of PAN protocol(s) can include Bluetooth, Zigbee, Wireless Universal Serial Bus (USB), Z-Wave, etc.; examples of LAN and/or WAN protocol(s) can include Institute of Electrical and Electronic Engineers (IEEE) 802.3 (also known as Ethernet), IEEE 802.11 (also known as WiFi), etc.; and examples of wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, examples of communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further examples of communication hardware can include wireless communication hardware including, for example, one or more radio transceivers, one or more infrared transceivers, etc. Additional examples of communication hardware can include one or more networking components (e.g., modulator-demodulator components, gateway components, etc.).

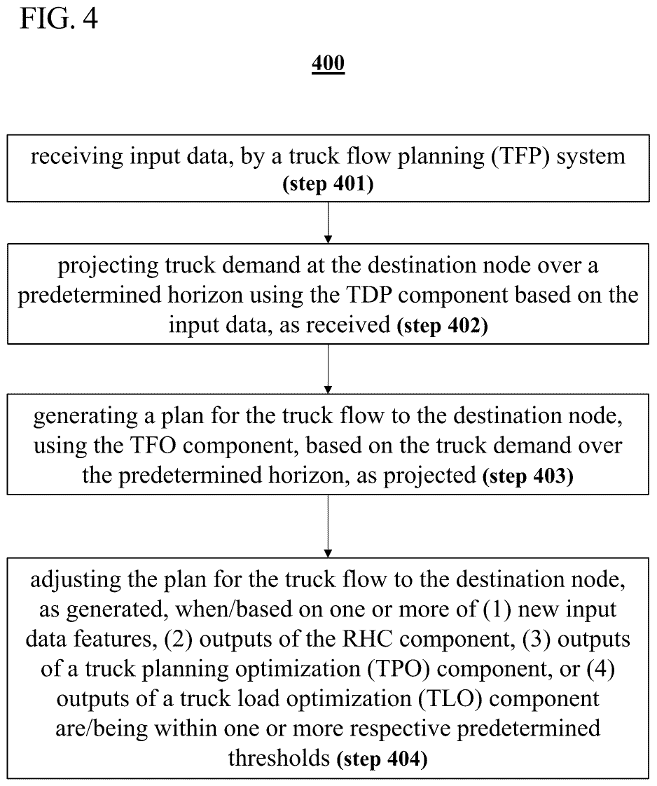

FIG. 4 illustrates a flowchart of a computer-implemented method for smoothing a truck flow to a destination node, according to an example embodiment.

According to some example embodiments, a system (e.g., the inbound order optimization (IO2) system that includes the truck flow planning (TFP) system for smoothing the truck flow to the destination node and/or the architecture of the TFP system for smoothing the truck flow to the destination node illustrated and described with reference to FIGS. 1 and 2, respectively) can be provided that can include a processor and a non-transitory computer-readable medium storing computing instructions that, when executed on the processor, can cause the processor to perform operations that include the computer-implemented method for smoothing the truck flow to the destination node.

According to some example embodiments, a non-transitory computer-readable medium storing computing instructions can be provided that, when executed on a processor, can cause the processor to perform operations including the computer-implemented method for smoothing the truck flow to the destination node.

According to some example embodiments, a computer-implemented method 400 for smoothing the truck flow to the destination node can include:
receiving input data, by a truck flow planning (TFP) system (step 401), the input data, as received, can include, for example, one or more of truck demand data, truck capacity constraints, or node capacity constraints, and the TFP system can include a truck flow optimization (TFO) component and one or more of a truck demand projection (TDP) component, or a receding horizon control (RHC) component;
projecting truck demand at the destination node over a predetermined horizon using the TDP component based on the input data, as received (step 402);
generating a plan for the truck flow to the destination node, using the TFO component, based on the truck demand over the predetermined horizon (e.g., a predetermined future time period), as projected (step 403), the generating can include formulating/determining/implementing the plan for the truck flow to the destination node as a Mixed Integer Programming (MIP) problem, constraints used in the smoothing the plan for the truck flow (e.g., the plan for the truck flow to the destination node, as formulated/determined by the MIP) can include one or more of a maximum truck constraint, a no shortage of trucks constraint, or a needed truck conservation constraint, and the plan for the truck flow, as generated, can reduce truck flow variability (e.g., a predetermined truck threshold quantity or range for at least a portion of the predetermined horizon) at the destination node while at least maintaining item (e.g., stock item, replenished item, shipped item, etc.) and/or truck inventory health (e.g., predetermined minimum amounts, predetermined maximum amounts, predetermined buffer amounts, etc.) at the destination node and/or the source node; and
adjusting the plan for the truck flow to the destination node, as generated, when/based on one or more of (1) new input data features, (2) outputs of the RHC component, (3) outputs of a truck planning optimization (TPO) component, or (4) outputs of a truck load optimization (TLO) component are/being within one or more respective predetermined thresholds (step 404), the plan for the truck flow, as generated and adjusted, can be based on a rolling time window (e.g., a rolling predetermined horizon that updates daily).

In an embodiment, the computer-implemented method 400 for smoothing the truck flow to the destination node can further include performing the plan for the truck flow, as generated or adjusted, by the TFP system and/or IO2 system directly, and/or indirectly by transmitting computer-readable instructions, via relevant automated systems for truck loading and/or components/machines thereof.

In an embodiment, the computer-implemented method 400 for smoothing the truck flow to the destination node can further include deploying a smart fleet of autonomous trucks by the IO2 system and/or the TFP system directly, and/or indirectly by transmitting computer-readable instructions, via onboard computing systems of the autonomous trucks being routed to the destination node or other relevant systems for truck deployment, based on the plan for the truck flow, as generated or adjusted.

In an embodiment, the computer-implemented method 400 for smoothing the truck flow to the destination node can further include projecting the truck demand at the destination node over the predetermined horizon, which can include estimating truck demands for different truck types, wherein the different truck types include one or more of truck types required for various chamber types or appointment types (e.g., live, drop, different truck types required for specific temperature-controlled chambers and/or time-specific delivery appointments, etc.).

In an embodiment, the computer-implemented method 400 for smoothing the truck flow to the destination node can further include generating the plan for the truck flow to the destination node, which can include planning a number of trucks available at the destination node on each day within a predetermined range/limit, which can include a variable accounting for a max capacity breach.

In an embodiment, the computer-implemented method 400 for smoothing the truck flow to the destination node can further include generating the plan for the truck flow to the destination node, which can include planning a total number of trucks sent to the destination node until a given date that is greater than or equal to a total number of trucks needed at the destination node until the given date (e.g., a terminal date of the predetermined horizon or a portion thereof).

In an embodiment, the computer-implemented method 400 for smoothing the truck flow to the destination node can further include generating the plan for the truck flow to the destination node, which can include determining/ensuring a total number of trucks sent over the predetermined horizon equals a total number of trucks needed over the predetermined horizon.

In an embodiment, the computer-implemented method 400 for smoothing the truck flow to the destination node can further include generating the plan for the truck flow to the destination node, which can further include minimizing a sum of squares of deviations from a baseline truck need at the destination node.

In an embodiment, the computer-implemented method 400 for smoothing the truck flow to the destination node can further include generating the plan for the truck flow to the destination node, which can include sending trailers (e.g., pre-loaded trucks/truck containers) to the destination node in advance to accommodate increased truck demand, avoid truck flow variability, and/or preserve/help ensure at least maintenance of one or more of inventory health at the destination node and/or the source node, truck availability at the destination node and/or the source node, or item delivery at the destination node.

In an embodiment, the computer-implemented method 400 for smoothing the truck flow to the destination node can further include using constraints in smoothing the plan for the truck flow to the destination node (e.g., the plan for the truck flow to the destination node, as formulated/determined by the MIP) including one or more of a maximum truck constraint, a no shortage of trucks constraint, or a needed truck conservation constraint.

The computer-implemented method 400 for smoothing the truck flow to the destination node is merely an example and is not limited to the embodiments presented herein. The computer-implemented method 400 for smoothing the truck flow to the destination node can be employed in many different embodiments or examples not specifically depicted or described herein. In some embodiments, the procedures, the processes, and/or the activities of the computer-implemented method 400 for smoothing the truck flow to the destination node can be performed in the order presented. In other embodiments, the procedures, the processes, and/or the activities of the computer-implemented method 400 for smoothing the truck flow to the destination node can be performed in any suitable order. In still other embodiments, one or more of the procedures, the processes, and/or the activities of the computer-implemented method 400 for smoothing the truck flow to the destination node can be combined or skipped.

FIG. 5 illustrates a front elevational view of a computer system that is suitable for implementing an embodiment of the system disclosed in FIG. 1.

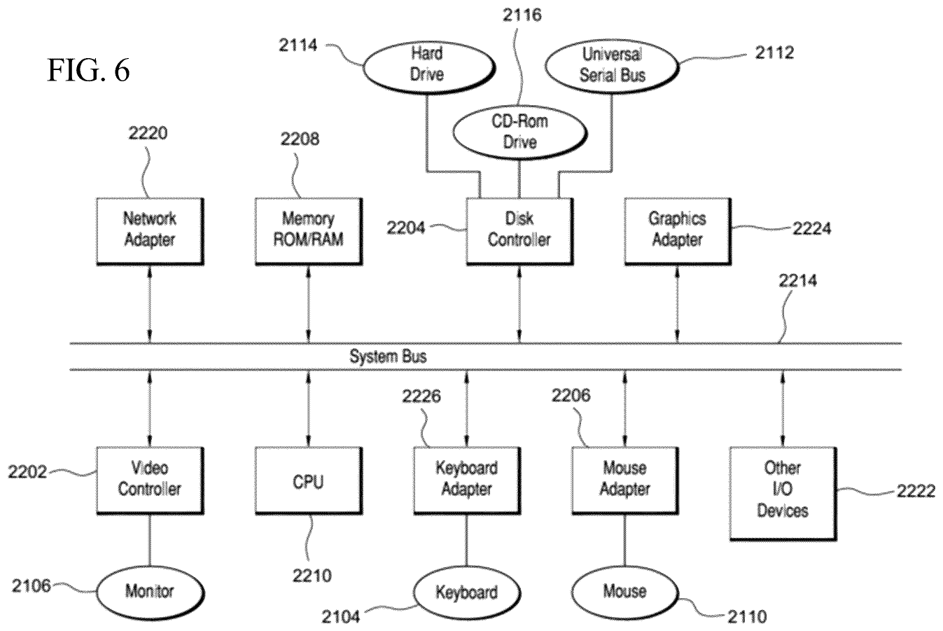

FIG. 6 illustrates a representative block diagram of an example of the elements included in the circuit boards inside a chassis of the computer system of FIG. 5.

Turning to the drawings, FIG. 5 illustrates an embodiment of three different types (e.g., a tower server, a laptop, and a smart phone) of a computer system 2100. FIG. 6 illustrates a representative block diagram of elements included on the circuit boards inside a chassis 2102 of computer system 2100. All or a port of computer system 2100 can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 2100 (and its internal components, or one or more elements of computer system 2100) can be suitable for implementing part or all of the techniques described herein. Computer system 2100 can comprise chassis 2102 containing one or more circuit boards (not shown) and one or more of an input/output port 2112 (e.g., one or more Universal Serial Bus (USB) ports of one or more types (e.g., USB type-A, type-B, type-C, micro-A, micro-B, mini-A, mini-B, etc.), one or more High-Definition Multimedia interface (HDMI) ports, etc.).

A central processing unit (CPU) 2210 is coupled to a system bus 2214. In various embodiments, the architecture of CPU 2210 can be compliant with any of a variety of commercially distributed architecture families. System bus 2214 also can be coupled to memory storage unit 2208 that includes both read only memory (ROM) and random-access memory (RAM). Non-volatile portions of memory storage unit 2208 or the ROM can be encoded with a boot code sequence suitable for restoring computer system 2100 to a functional state after a system reset. In addition, memory storage unit 2208 can include microcode such as a Basic Input-Output System (BIOS). In some examples, the one or more memory storage units of the various embodiments disclosed herein can include memory storage unit 2208, a USB-equipped electronic device (e.g., an external memory storage unit (not shown) coupled to input/output port 2112), hard drive 2114, and/or one or more CD-ROM, DVD, Blu-Ray, or other suitable media, such as media configured to be used in CD-ROM and/or DVD drive 2116 inside chassis 2102 or in a detachable driver coupled to input/output port 2112.

Non-volatile or non-transitory memory storage unit(s) refer to the portions of the memory storage unit(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Example operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further examples of operating systems can comprise one of the following: (i) the iOS® operating system by Apple Inc. of Cupertino, California, United States of America, or (ii) the Android™ operating system developed by Google, of Mountain View, California, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 2210.

Various I/O devices such as a disk controller 2204, a graphics adapter 2224, a video controller 2202, a keyboard adapter 2226, a mouse adapter 2206, a network adapter 2220, and other I/O devices 2222 can be coupled to system bus 2214. Keyboard adapter 2226 and mouse adapter 2206 can be coupled to a keyboard 2104 and a mouse 2110, respectively, of computer system 2100. While graphics adapter 2224 and video controller 2202 are shown as distinct units, video controller 2202 can be integrated into graphics adapter 2224, or vice versa in other embodiments. Video controller 2202 is suitable for refreshing a monitor 2106 to display images on a screen 2108 of computer system 2100. Disk controller 2204 can control hard drive 2114, input/output port 2112, and CD-ROM and/or DVD drive 2116. In other embodiments, distinct units can be used to control each of these devices separately.

In some embodiments, network adapter 2220 can comprise and/or be implemented as a WNIC (wireless network interface controller) card (not shown) plugged or coupled to an expansion port (not shown) in computer system 2100. In other embodiments, the WNIC card can be a wireless network card built into computer system 2100. A wireless network adapter can be built into computer system 2100 by having wireless communication capabilities integrated into the motherboard chipset (not shown), and/or implemented via one or more dedicated wireless communication chips (not shown), connected through a PCI (peripheral component interconnector) or a PCI express bus of computer system 2100 or input/output port 2112. In other embodiments, network adapter 2220 can comprise and/or be implemented as a wired network interface controller card (not shown).

Although many other components of computer system 2100 are not shown, such components and their interconnection are well known to those of ordinary skill in the art. Accordingly, further details concerning the construction and composition of computer system 2100 and the circuit boards inside chassis 2102 are not discussed herein.

When computer system 2100 is running, program instructions stored on a USB drive in input/output port 2112, on a CD-ROM or DVD in CD-ROM and/or DVD drive 2116 or in the detachable CD-ROM and/or DVD drive coupled to input/output port 2112, on hard drive 2114, or in memory storage unit 2208 are executed by CPU 2210. A portion of the program instructions, stored on these devices, can be suitable for carrying out all or at least part of the techniques described herein. In various embodiments, computer system 2100 can be reprogrammed with one or more modules, system, applications, and/or databases, such as those described herein, to convert a general-purpose computer to a special purpose computer. For purposes of illustration, programs and other executable program components are shown herein as discrete systems, although it is understood that such programs and components can reside at various times in different storage components of computer system 2100 and can be executed by CPU 2210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 2100 is illustrated as a laptop computer, tower server, and smartphone, there can be examples where computer system 2100 can take a different form factor while still having functional elements like those described for computer system 2100. In some embodiments, computer system 2100 can comprise a single computer, a single server, or a cluster or collection of computers or servers, or a cloud of computers or servers. Typically, a cluster or collection of servers can be used when the demand on computer system 2100 exceeds the reasonable capability of a single server or computer. In certain embodiments, computer system 2100 may comprise a portable computer, such as a laptop computer. In certain other embodiments, computer system 2100 can comprise a mobile device, such as a smartphone, smart glasses, smart rings, wearable, virtual reality headset, augmented reality glasses, etc. In certain additional embodiments, computer system 2100 can comprise an embedded system.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although systems and methods for smoothing a truck flow to a destination node with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 can be modified, and that the foregoing discussion of certain of these embodiments does not necessarily represent a complete description of all possible embodiments. For example, one or more of the procedures, processes, or activities illustrated and described herein can include different procedures, processes, and/or activities and be performed by many different modules, in many different orders, and/or one or more of the procedures, processes, or activities of FIGS. 1-6 can include one or more of the procedures, processes, or activities of another different one of FIGS. 1-6. As another example, the elements illustrated and described with reference to FIG. 1 can be interchanged and/or otherwise modified.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.05 second, 0.1 second, 0.02 second, 0.5 second, one second, two seconds, five seconds, or ten seconds.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor and a non-transitory computer-readable medium storing computing instructions that, when executed on the processor, cause the processor to perform operations comprising a computer-implemented method for smoothing a truck flow to a destination node, comprising:
receiving input data, by a truck flow planning (TFP) system, wherein the input data, as received, includes truck demand data, truck capacity constraints, and node capacity constraints, and wherein the TFP system includes a truck demand projection (TDP) component, a truck flow optimization (TFO) component, and a receding horizon control (RHC) component;
projecting truck demand at the destination node over a predetermined horizon, using the TDP component, based on the input data, as received;
generating a plan for the truck flow to the destination node, using the TFO component, based on the truck demand over the predetermined horizon, as projected, wherein the generating includes formulating the plan for the truck flow to the destination node as a Mixed Integer Programming (MIP) problem, and wherein the plan for the truck flow, as generated, reduces truck flow variability at the destination node while at least maintaining inventory health at the destination node; and
adjusting the plan for the truck flow to the destination node, as generated, when one or more of (1) new input data features, (2) outputs of the RHC component, (3) outputs of a truck planning optimization (TPO) component, or (4) outputs of a truck load optimization (TLO) component are within one or more respective predetermined thresholds.

2. The system of claim 1, wherein the projecting the truck demand at the destination node over the predetermined horizon further comprises estimating truck demands for different truck types, wherein the different truck types include one or more of truck types required for various chamber types or appointment types.

3. The system of claim 1, wherein the generating the plan for the truck flow to the destination node further comprises planning a number of trucks available at the destination node on each day to be within a predetermined limit, with a variable accounting for a max capacity breach.

4. The system of claim 1, wherein the generating the plan for the truck flow to the destination node further comprises planning a total number of trucks sent to the destination node until a given date to be greater than or equal to a total number of trucks needed at the destination node until the given date.

5. The system of claim 1, wherein the generating the plan for the truck flow to the destination node further comprises ensuring a total number of trucks sent over the predetermined horizon equals a total number of trucks needed over the predetermined horizon.

6. The system of claim 1, wherein the generating the plan for the truck flow to the destination node further comprises minimizing a sum of squares of deviations from a baseline truck need.

7. The system of claim 1, wherein the generating the plan for the truck flow to the destination node comprises sending one or more of trucks or trailers to the destination node in advance to accommodate increased truck demand at the destination node.

8. The system of claim 1, wherein the plan for the truck flow to the destination node, as generated or adjusted, is based on a rolling time window.

9. The system of claim 1, wherein constraints used in the plan for the truck flow to the destination node, as generated or adjusted, include one or more of a maximum truck constraint, a no shortage of trucks constraint, or a needed truck conservation constraint.

10. The system of claim 1, wherein an objective function used in the generating the plan for the truck flow to the destination node includes one or more of a max capacity breach constraint, a coefficient of variation (CV) constraint, or a pull forward trucks constraint.

11. A computer-implemented method for smoothing a truck flow to a destination node, comprising:
receiving input data, by a truck flow planning (TFP) system, wherein the input data, as received, includes truck demand data, truck capacity constraints, and node capacity constraints, and wherein the TFP system includes a truck demand projection (TDP) component, a truck flow optimization (TFO) component, and a receding horizon control (RHC) component;
projecting truck demand at the destination node over a predetermined horizon using the TDP component based on the input data, as received;
generating a plan for the truck flow to the destination node, using the TFO component, based on the truck demand over the predetermined horizon, as projected, wherein the generating includes formulating the plan for the truck flow to the destination node as a Mixed Integer Programming (MIP) problem, wherein constraints used in the smoothing the plan for the truck flow to the destination node include a maximum truck constraint, a no shortage of trucks constraint, and a needed truck conservation constraint, and wherein the plan for the truck flow, as generated, reduces truck flow variability at the destination node while at least maintaining inventory health at the destination node; and
adjusting the plan for the truck flow to the destination node, as generated, when one or more of (1) new input data features, (2) outputs of the RHC component, (3) outputs of a truck planning optimization (TPO) component, or (4) outputs of a truck load optimization (TLO) component are within one or more respective predetermined thresholds, wherein the plan for the truck flow, as generated and adjusted, is based on a rolling time window.

12. The computer-implemented method of claim 11, wherein the projecting the truck demand at the destination node over the predetermined horizon further comprises estimating truck demands for different truck types, wherein the different truck types include one or more of truck types required for various chamber types or appointment types.

13. The computer-implemented method of claim 11, wherein the generating the plan for the truck flow to the destination node further comprises planning a number of trucks available at the destination node on each day to be within a predetermined limit, with a variable accounting for a max capacity breach.

14. The computer-implemented method of claim 11, wherein the generating the plan for the truck flow to the destination node further comprises planning a total number of trucks sent to the destination node until a given date to be greater than or equal to a total number of trucks needed at the destination node until the given date.

15. The computer-implemented method of claim 11, wherein the generating the plan for the truck flow to the destination node further comprises ensuring a total number of trucks sent over the predetermined horizon equals a total number of trucks needed over the predetermined horizon.

16. The computer-implemented method of claim 11, wherein the generating the plan for the truck flow to the destination node further comprises minimizing a sum of squares of deviations from a baseline truck need.

17. The computer-implemented method of claim 11, wherein the generating the plan for the truck flow to the destination node comprises sending one or more of trucks or trailers to the destination node in advance to accommodate increased truck demand at the destination node.

18. A non-transitory computer-readable medium storing computing instructions that, when executed on a processor, cause the processor to perform operations comprising a computer-implemented method for smoothing a truck flow to a destination node, the computer-implemented method comprising:
receiving input data, by a truck flow planning (TFP) system, wherein the input data, as received, includes truck demand data, truck capacity constraints, and node capacity constraints, and wherein the TFP system includes a truck demand projection (TDP) component, a truck flow optimization (TFO) component, and a receding horizon control (RHC) component;
projecting truck demand at the destination node over a predetermined horizon using the TDP component based on the input data, as received;
generating a plan for the truck flow to the destination node, using the TFO component, based on the truck demand over the predetermined horizon, as projected, wherein the generating includes formulating the plan for the truck flow to the destination node as a Mixed Integer Programming (MIP) problem, wherein constraints used in the smoothing the plan for the truck flow to the destination node include a maximum truck constraint, a no shortage of trucks constraint, and a needed truck conservation constraint, and wherein the plan for the truck flow, as generated, reduces truck flow variability at the destination node while at least maintaining inventory health at the destination node; and
adjusting the plan for the truck flow to the destination node, as generated, based on one or more of (1) new input data features, (2) outputs of the RHC component, (3) outputs of a truck planning optimization (TPO) component, or (4) outputs of a truck load optimization (TLO) component being within one or more respective predetermined thresholds, wherein the plan for the truck flow, as generated and adjusted, is based on a rolling time window.

19. The non-transitory computer-readable medium storing the computing instructions of claim 18, wherein constraints used in the smoothing the plan for the truck flow to the destination node include one or more of a maximum truck constraint, a no shortage of trucks constraint, or a needed truck conservation constraint.

20. The non-transitory computer-readable medium storing the computing instructions of claim 18, wherein an objective function used in the generating the plan for the truck flow to the destination node includes one or more of a max capacity breach constraint, a coefficient of variation (CV) constraint, and a pull forward trucks constraint.
